(19) United States
(12) Patent Application Publication
(10) Pub. No.: US 2017/0274731 A1
(43) Pub. Date: Sep. 28, 2017

(54) HVAC BLOWER ADJUSTABLE DIVERGENCE

(71) Applicants: DENSO International America, Inc., Southfield, MI (US); DENSO CORPORATION, Kariya-city (JP)

(72) Inventor: John Klinkhammer, Canton, MI (US)

(21) Appl. No.: 15/082,384

(22) Filed: Mar. 28, 2016

(51) Int. Cl. B60H 1/00

(52) U.S. Cl. CPC B60H 1/00842; B60H 1/00521; B60H 1/00678; B60H 1/00471; B60H 2001/00721; B60H 2001/00135

(57) ABSTRACT

A HVAC system is provided for use in a vehicle. The HVAC system includes a HVAC housing that contains a series of heat exchangers to heat and cool the passenger cabin of a vehicle. A blower fan may be disposed in a blower housing that is connected to the HVAC housing. The blower housing may contain a scroll portion that surrounds the blower fan. A door may be disposed in the scroll portion to adjust the volume of the scroll portion.

### FIELD

The present disclosure relates to heating, ventilating, and air-conditioning (HVAC) systems in vehicles and, more particularly, relates to the blower housing of the HVAC.

### BACKGROUND

This section provides background information related to the present disclosure which is not necessarily prior art.

The present disclosure relates generally to automotive vehicle climate control HVAC systems, it is common to have a climate control system located within an instrument panel which provides heated or cooled air to occupants through dash panel defrost air outlets, instrument panel venting air outlets and floor directed air outlets.

### SUMMARY

This section provides a general summary of the disclosure, and is not a comprehensive disclosure of its full scope or all of its features.

According to the present teachings, in some embodiments an HVAC system may comprise a blower housing that has an inlet and an outlet. The outlet may have a width and a height. A blower fan may also be located between the inlet and outlet. The blower fan may be encased in a scroll portion of the blower housing. The scroll portion may have an outside wall that surrounds the perimeter of the blower fan. The outside wall may increase in distance away from the fan as the outside wall approaches the outlet to establish the width of the outlet. Also, the scroll portion may have a top wall that helically increases in distance away from the blower fan as the top wall approaches the outlet to establish the height of the outlet. Additionally a door may be located in the scroll portion that adjusts the height of the outlet.

In some embodiments a HVAC module may have a cylindrical blower fan and a scroll portion that surrounds the blower fan. The scroll portion may have a outside wall and a top wall. The top wall of the scroll portion may gradually extend away from the blower fan axially at an angle, similar to a helix. The outside wall may gradually increase a distance away from the blower fan radially. The HVAC module may also contain a divergence door located in the scroll portion adjacent to the top wall that adjustably reduces a volume of the scroll portion.

In some embodiments a vehicle HVAC system may comprise a HVAC housing and a blower housing that may be connected to the HVAC housing at a connection joint. A evaporator may be disposed in the HVAC housing, the evaporator may have a upstream side and a downstream side. A blower may be located in a scroll portion of the blower housing upstream of the evaporator, the scroll portion may gradually increase in volume from the blower to the connection joint. The increase in volume of the scroll portion may be made up by a horizontal divergence portion and a vertical divergence portion. A door may be disposed in the scroll portion to adjust the vertical divergence.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustrative purposes only of selected embodiments and not all possible implementations, and are not intended to limit the scope of the present disclosure.

FIG. 1 is a schematic representation of a vehicle having a HVAC system;

FIG. 2 is a representation the passenger space of the vehicle;

FIG. 3 is a diagram of the HVAC module;

FIG. 4A is section view of the blower housing;

FIG. 4B is another section view of the blower housing;

FIG. 5A is a diagram of the HVAC module;

FIG. 5B is section view of the blower housing;

FIG. 5C is a view of the door;

FIG. 6A is another diagram of the HVAC module; and

FIG. 6B is another diagram of the HVAC module;

Corresponding reference numerals indicate corresponding parts throughout the several views of the drawings.

### DETAILED DESCRIPTION

Example embodiments will now be described more fully with reference to the accompanying drawings. The following description is merely exemplary in nature and is not intended to limit the present disclosure, application, or uses. It should be understood that throughout the drawings, corresponding reference numerals indicate like or corresponding parts and features.

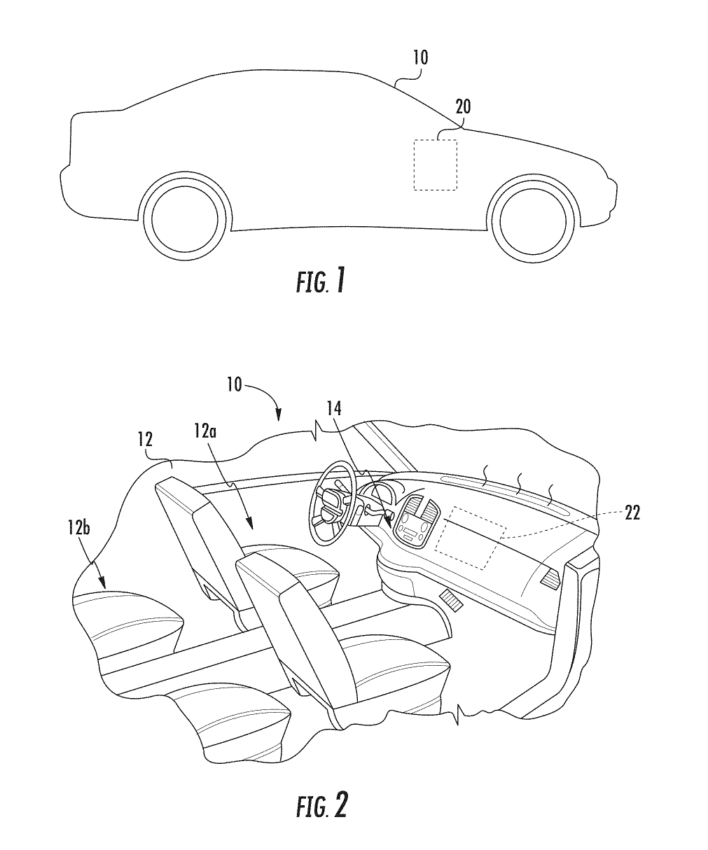

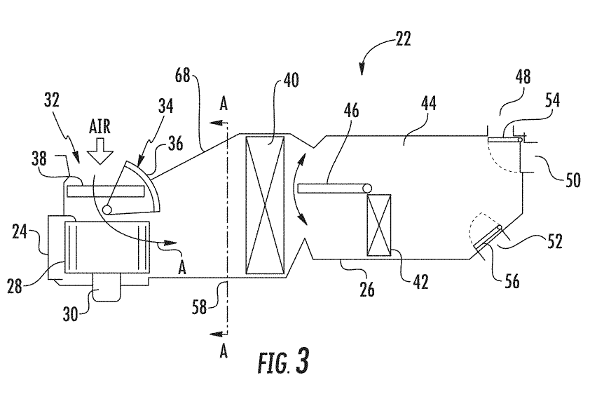

Referring to FIGS. 1 & 2, an automotive vehicle 10 with an HVAC system 20 within which an HVAC module 22 according to the present teachings can be utilized is shown. Vehicle 10 includes a passenger cabin 12 which may have both a front passenger compartment 12a and a rear passenger compartment 12b. HVAC controls 14 allow adjustment of the operation of HVAC module 22 to provide desired flows of conditioned air.

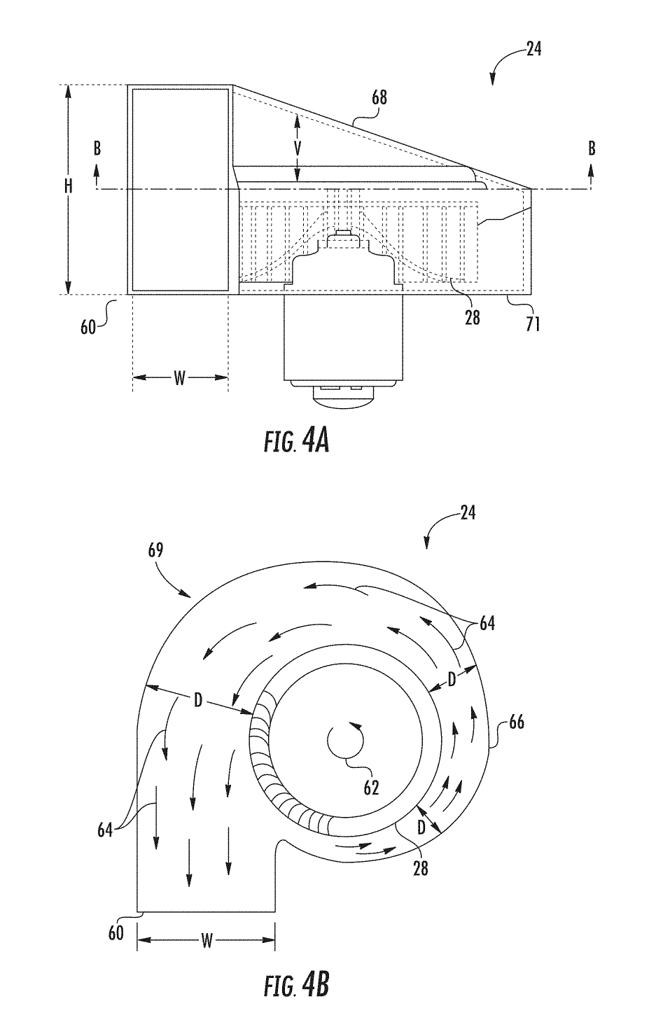

With reference to FIG. 3, a diagram of a conventional vehicle HVAC module 22 is shown. Generally an HVAC module 22 is made of two cases or housings, a blower or fan case 24 also known in the art as a scroll housing and a HVAC case 26. The blower case 24 contains a generally cylindrical fan, or known in the art as a blower 28, which is powered by a motor 30. The blower case 24 also contains a fresh air inlet 32 and a recirculation inlet 34, the inlets 32, 34 are positioned generally perpendicular of the cylindrical blower 28. A fresh/recirc door 36 is arranged upstream of an air filter 38 which is upstream of the blower 28. The fresh/recirc door 36 is used to regulate air flow from the fresh air inlet 32 or recirculation inlet 34 based on the control of the system and user input. Generally air represented by arrow A is drawn through an inlet 32, 34 through filter 38 enters the blower 28 axially and exits the blower tangentially toward the HVAC case 26. Arranged downstream of the blower 28 is a first heat exchanger or evaporator 40. The evaporator 40 is connected to an air conditioning system (not shown) which provides low pressure refrigerant into the evaporator 40, the refrigerant absorbs heat from the air inside the HVAC case 26 and provides cool or conditioned air into the vehicle 10 passenger cabin 12. On the downstream side of the evaporator 40, the HVAC case 26 also has a second heat exchanger or hot water heater core 42. The heater core 42 includes an inlet and an outlet (not shown) that is connected to the engine cooling system and has hot water (coolant) flowing through it to heat the air flowing from the blower 28 through the HVAC case 26. An air bypass channel 44 is formed beside the heater core 42. An air distribution door or blend air door 46 is provided to adjust the volume ratio between warm air and cool air that passes through the heater core 42 and the bypass channel 44, respectively.

Additionally, the HVAC case 26 may have a plurality of outlets; a defroster outlet 48, a face outlet 50, a foot outlet 52 is shown by way of non-limiting example. It can also be understood in the art there may be a rear passenger compartment 12b outlet (not shown), or any other arrangement of outlets out of the HVAC case 26. The face outlet 50 directs air toward the upper body portions of passengers, the defroster outlet 48 directs air toward the internal surface of a windshield, the foot outlet 52 directs air toward the feet of the front seat passengers. The outlets 48, 50, and 52 are opened and closed by outlet mode doors 54 and 56 by way of non-limiting example. The blower case 24 and the HVAC case 26 are generally two cases that are connected between the blower 28 and the evaporator 40, for example the division between the two cases 24, 26 is represented by connecting or connection line 58 also known as connection joint, the two cases 24, 26 may be connected by snap features (not shown), fasteners (not shown) or any other suitable means to connect the two plastic cases.

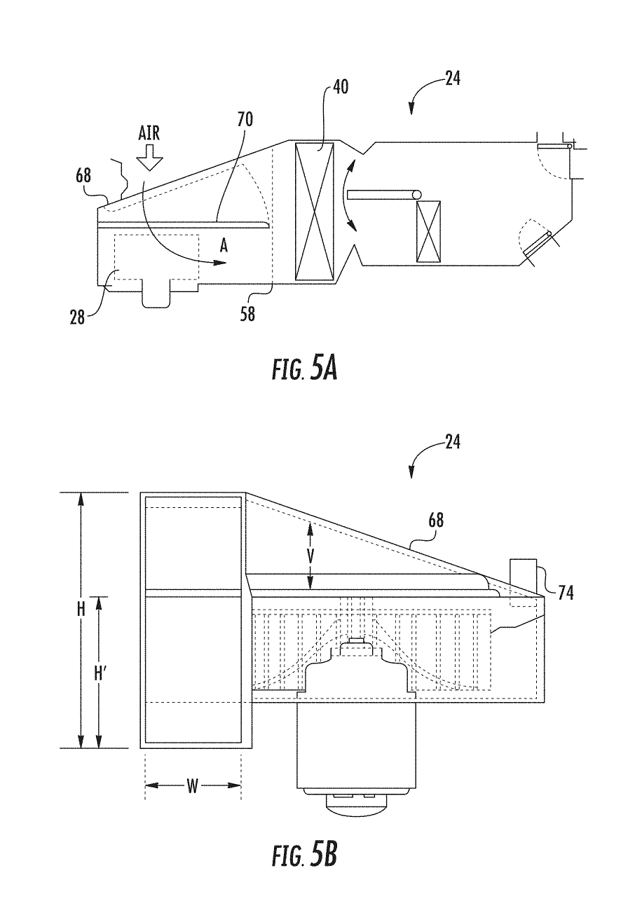

Referring to FIG. 4A which shows a section view of A-A from FIG. 3 which is connecting line 58. FIG. 4B is a top view of section B-B. Blower case 24 has an outlet 60 that is generally rectangular in shape represented by H and width represented by W of FIG. 4A. During operation, in this example, the blower fan 28 will turn counter clockwise represented by arrow 62. The air flow generated by the blower fan 28 is represented by arrows 64. As known in the art, the distance D, from the blower fan 28 to the scroll outside wall 66 of the blower case 24, increases in a counter clockwise manner around the blower case 24. This is known as horizontal divergence. Similarly, the vertical distance V of the top wall 68 increases in distance axially away from the blower fan 28 in a counter clockwise helical manner, known in the art as vertical divergence, combined volume around the blower fan 28 is known in the art as the scroll portion 69 or scroll case. The horizontal and vertical divergence allows the blower case 24 scroll portion 69 volume to increase gradually and the outlet 60 to be larger for the increased airflow 64 flowing out of the blower case 24 and into the HVAC case 26. This larger outlet 60 and gradual increase in divergence of the scroll portion 69 allows the air flow to develop in the blower case 24 and provide a consistent non-turbulent airflow out of the blower case 24. In this example, the blower case 24 has a bottom wall 71 that is parallel with the bottom of the blower fan 28 by way of non-limiting example. the bottom wall 71 may angle away from the blower 28 similar to the top wall 68 to further increase vertical divergence but is shown parallel for example purposes. Generally, in automotive applications, the horizontal and vertical divergence is fixed and the divergence shape and design are determined based on ideal conditions or settings based on the structure of the HVAC case 26, or passenger cabin 12.

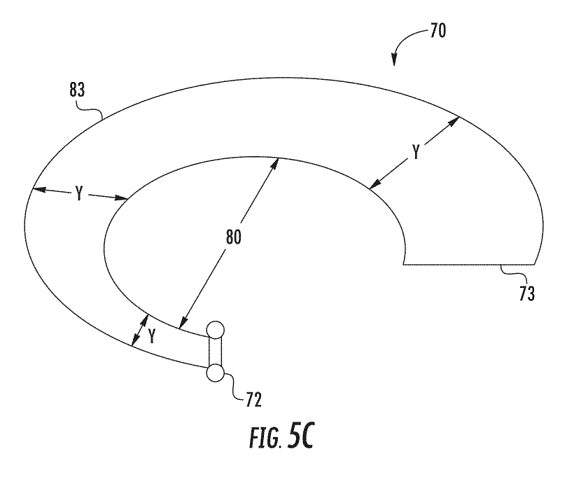

Referring now to FIG. 5A and FIG. 5B, the fresh/recirc door 36 and similar components are removed for clarity; a door 70 may be located adjacent to top wall 68 of the blower case 24. The door 70, also known as a damper, restrictor, divergence door or a first door, adjusts the vertical divergence of the blower case 24. The door 70 may rotate about axis 72, shown in FIG. 5C, and adjust the vertical divergence of the blower case 24 from H to H′ shown in FIG. 5B and any range there between. The axis 72 is disposed near the base of top wall 68. The door may be rotated by servo 74, by way of non-limiting example. Additionally it is known in the art that a servo 74 and link can be used or any other motor to rotate door 70 about axis 72. As, shown in FIG. 5C the door is the general shape of the horizontal divergence of the scroll portion 69. The door width Y is smaller close to the axis 72 and gradually increases in width Y as it approaches the end 73 of the door 70. The inside diameter 81 of the door 70 is slightly larger than the blower fan 28. The outside edge 83 fits within the scroll portion 69 of the blower housing 24 and has similar shape to the scroll outside wall 66. The width Y corresponds to the distance D of the scroll portion 69 of the blower housing 24. The door 70 maintains this shape to influence the scroll portion 69 of the blower housing 24.

The door 70 is placed closer to the blower fan 28 to influence the development of the airflow A by adjusting the vertical divergence, essentially reducing the volume of the blower case 24. If the volume in the blower case is reduced, the velocity of the airflow generated by the blower 28 can be maintained as the airflow travels through the blower case 24, thus entering the HVAC case 26 at a higher velocity. This higher velocity airflow may overcome static pressures of the HVAC case 26 easier and deliver air to the passenger cabin 12 more quickly; this is known in the art as punch. The static pressures of the HVAC case 26 may depend on several factors. By non-limiting example a factor may be the structure and packaging of the HVAC case, or the layout of the heat exchangers. Another may be the settings of the HVAC system 20, for instance if the user is requesting air flow out of certain outlets 48, 50, 52. On the other hand, in a typical set up, the blower case 24 maintains a large volume, the velocity of the air diminishes, or less punch, going from a small volume in the blower 28 to the blower case 24 and the air velocity reduces even further moving into the larger HVAC case 26, thus increasing the amount of time and pressure the air has to overcome to flow from the blower 28 to the passenger cabin 12. Additionally, the same effect of reducing the vertical divergence or volume of the blower case 24 cannot be achieved by simply restricting the outlet of the blower case 24. This would allow the airflow to develop in the blower case 24, then be restricted at the outlet and increase back pressure and reduce airflow and pressure flowing into the HVAC case 26, which would be a determent to the air flowing into the passenger cabin 12 and reduce overall efficiency.

The opening/closing position of the door 70 can be determined by several factors. As stated above, during initial startup of the HVAC system 20, the door 70 may be in the position as shown in FIG. 5A, closed position, to help keep the velocity of airflow A high to punch the static air through the HVAC case 26. As the HVAC system 20 runs for a period of time the control of the HVAC system 20 can open door 70 gradually toward top wall 68 to allow the full volume of the blower case 24, this may be referred to as open position. In the open position, the blower 28 can generate a maximum airflow out of the blower case 24 and into the HVAC case 26. The maximum airflow may be beneficial in a cool down of a very hot vehicle 12 by way of non-limiting example. Another example, the door 70 may be in a closed position during heat mode, when the airflow is directed through the heater core 42. Because the airflow must then flow through the evaporator 40 and heater core 42, a higher back pressure may develop in the HVAC module 22; the door 70 being in the closed position would allow the airflow to reach a higher velocity to overcome the back pressure.

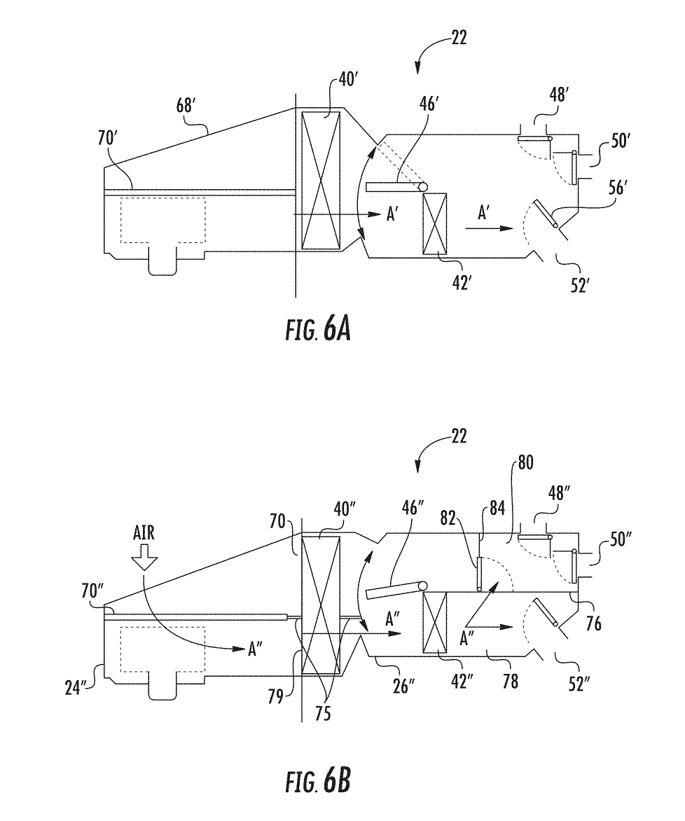

Referring to FIG. 6A, displays a slightly different embodiment and layout of HVAC module 22′, in which outlets 48′, 50′, 52′ each have outlet mode doors respectively. In this setting, by way of non-limiting example perhaps the user would like heat on and air at the user's feet. The blend air door 46′ generally would be in a first position displayed by the dotted line or full hot mode; however the blend air door 46′ may be positioned in a second position in concert with door 70′ to reduce the vertical divergence of the blower case 24′, to split the evaporator 40′. The doors 70′ and 46′ aligning on the same plane directs the high velocity airflow A′ through the bottom portion of the evaporator 40′, through the heater core 42′ and out the open the foot outlet 52′. This setting would be used to maximize airflow efficiency during a certain setting to concentrate the airflow A′ to the area of the HVAC module 22′ where the airflow A′ is needed. In this non-limiting example, the layout is shown that outlet door 56′ is open which is adjacent to the heater core 42′, any outlet or configuration can use this logic.

Referring to FIG. 6B which is another embodiment and use of the present disclosure. A partition 75 may be used in conjunction with vertical divergence door 70″. The partition 75 may split the evaporator 40″ into a upper region 77 and lower region 79 to allow a door 70″ and blend air door 46″ a surface to seal against and so no air can flow throw the evaporator 40″ upper region 77 and around the doors 70″ and 46″ respectively. Additionally the HVAC case 26″ may have a mode partition wall 76 that splits the different modes of the HVAC module 22″ into an upper chamber 78 and lower chamber 80. In this example shown, the foot outlet 52″ is below the mode partition wall 76 in the lower chamber 78 and the defrost outlet 48″ and face outlet 50″ are above the mode partition wall 76 in the upper chamber 80. A partition door 82 allows for fluid communication between the two chambers 78, 80, the partition door may abut a stop 84 when fully opened as shown in FIG. 6B. As discussed above, based on user input and airflow to different areas of passenger cabin 12, the vertical divergence door 70″ may reduce the vertical divergence to maintain velocity and system efficiency. In the example shown, the user may direct hot air to the windshield via defrost outlet 48″ and foot outlet 52″. The divergence door 70″ and blend air door 46″ may be positioned adjacent to partition wall 74 to not allow air leakage to the upper region 79 of the evaporator 40″. Partition door 82 is open to allow airflow A″ to flow through the heater core 42″ and to both upper 80 and lower 78 partition chambers and out the defrost outlet 48″ and foot outlet 52″. Using divergence door 70″ in conjunction with blend air door 46″ and mode partition wall 76 the volume of the blower case 24″ and HVAC case 26″ can be reduced. This reduction of volume will allow airflow A″ to maintain a high velocity and be more efficient because the airflow does not have to push through the entire volume of both cases 24″, 26″ thus reducing the pressure drop in the HVAC module 22″.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A HVAC system comprising:
a blower housing having an inlet and an outlet, the outlet having a width and a height;
a blower fan located fluidly between the inlet an outlet, the blower fan encased in a scroll portion of the blower housing, the scroll portion has a outside wall that surrounds a perimeter of the blower fan that increases in distance away from the fan as the outside wall approaches the outlet to establish the width of the outlet, a top wall that increases in distance helically away from the blower fan as the top wall approaches the outlet to establish the height of the outlet; and
a door located in the scroll portion that adjusts the height of the outlet.

2. The HVAC system according to claim 1, wherein the door rotates about an axis.

3. The HVAC system according to claim 2, wherein the door rotated by a servo motor disposed to an exterior of the blower housing.

4. The HVAC system according to claim 1, further comprising
a HVAC housing connected to the outlet;
an evaporator disposed in the HVAC housing downstream of the outlet; and
a heater core disposed in the HVAC housing downstream of the evaporator.

5. The HVAC system according to claim 4, further comprising
a bypass channel adjacent to the heater core; and
an air distribution door that adjusts a volume of air that flows to the bypass channel or heater core.

6. The HVAC system according to claim 5, wherein the door located in the scroll portion rotates from an open position to a closed position, the air distribution door rotates from a first position to a second position, when in the second position the air distribution door and door located in the scroll portion are along the same plane.

7. The HVAC system according to claim 4, further comprising
a bypass channel adjacent to the heater core; and
an air distribution door that adjusts a volume of air that flows to the bypass channel or heater core;
a partition that splits the evaporator into a upper and lower region;
a mode partition wall that is downstream of the heater core that splits the HVAC housing into a upper and lower chamber; and
a partition door that fluidly connects the upper and lower chamber.

8. The HVAC system according to claim 7 wherein the door located in the scroll portion rotates from an open position to a closed position, the air distribution door rotates from a first position to a second position, when in the second position the air distribution door seals against the partition and when in the closed position the door located in the scroll portion seals against the partition.

9. A HVAC module comprising:
a generally cylindrical blower fan;
a scroll portion that surrounds the blower fan; wherein the scroll portion has a outside wall and a top wall, the top wall gradually extending away from the blower fan helically, the outside wall gradually increasing a distance away from the blower fan radially; and
a divergence door disposed in the scroll portion adjacent to the top wall that adjustably reduces a volume of the scroll portion.

10. The HVAC module according to claim 9, further comprising
a HVAC housing connected to the scroll portion at a connection joint;
an evaporator disposed in the HVAC housing downstream of the blower fan;
a heater core disposed in the HVAC housing downstream of the evaporator;
a bypass channel adjacent to the heater core; and
an air distribution door that adjusts a volume of air that flows to the bypass channel or heater core.

11. The HVAC module according to claim 10, wherein the divergence door rotates from an open position to a closed position, the air distribution door rotates from a first position to a second position, when in the second position the air distribution door and door located in the scroll portion are along the same plane.

12. The HVAC module according to claim 10, further comprising
a partition that splits the evaporator into a upper and lower region;
a mode partition wall that is down stream of the heater core that splits the HVAC housing into a upper and lower chamber; and
a partition door that fluidly connects the upper and lower chamber, wherein the divergence door rotates from an open position to a closed position, the air distribution door rotates from a first position to a second position, when in the second position the air distribution door seals against the partition and when in the closed position the door located in the scroll portion seals against the partition.

13. The HVAC module according to claim 12, further comprising
a defrost outlet,
a face outlet, and
a foot outlet, wherein the defrost and face outlet are located in the upper chamber and the foot outlet is located in the lower chamber.

14. The HVAC module according to claim 9, wherein the divergence door rotates about an axis.

15. The HVAC module according to claim 14, wherein the door rotated by a servo motor disposed to an exterior of scroll portion.

16. A vehicle HVAC system comprising:
a HVAC housing;
a blower housing connected to the HVAC housing at a connection joint;
an evaporator disposed in the HVAC housing having a upstream side and a downstream side;
a blower located in a scroll portion of the blower housing upstream of the evaporator, the scroll portion gradually increasing in volume from the blower to the connection joint, the increase in volume of the scroll portion is made up by a horizontal divergence portion and a vertical divergence portion; and
a door disposed in the scroll portion to adjust the vertical divergence.

17. The vehicle HVAC system according to claim 16, further comprising
a heater core disposed in the HVAC housing downstream of the evaporator;
a bypass channel adjacent to the heater core; and
an air distribution door that adjusts a volume of air that flows to the bypass channel or heater core.

18. The vehicle HVAC system according to claim 17, wherein the door rotates from an open position to a closed position to reduce the vertical divergence, the air distribution door rotates from a first position to a second position, when in the second position the air distribution door and the door are along the same plane.

19. The vehicle HVAC system according to claim 17, further comprising
a partition that splits the evaporator into a upper and lower region;
a mode partition wall that is down stream of the heater core that splits the HVAC housing into a upper and lower chamber; and
a partition door that fluidly connects the upper and lower chamber,
wherein the door rotates from an open position to a closed position, the air distribution door rotates from a first position to a second position, when in the second position the air distribution door seals against the partition and when in the closed position the door seals against the partition.

20. The vehicle HVAC system according to claim 19, wherein the door rotates about an axis and the door rotated by a servo motor disposed to an exterior of the blower housing.
